(19) United States
(12) Patent Application Publication
(10) Pub. No.: US 2023/0150494 A1
(43) Pub. Date: May 18, 2023

(54) SYSTEM AND METHODS FOR ENGAGEMENT IN HANDS-OFF LANE CENTERING APPLICATIONS

(71) Applicant: GM GLOBAL TECHNOLOGY OPERATIONS LLC, Detroit, MI (US)

(72) Inventors: Paul A. Adam, Milford, MI (US); Reza Zarringhalam, Whitby (CA); Tetyana V. Mamchuk, Walled Lake, MI (US); Mohammadali Shahriari, Markham (CA); Daryl A. Wilson, Brighton, MI (US)

(73) Assignee: GM GLOBAL TECHNOLOGY OPERATIONS LLC, Detroit, MI (US)

(21) Appl. No.: 17/455,168

(22) Filed: Nov. 16, 2021

(51) Int. Cl. B60W 30/12; B60W 60/00; B60W 50/08; B60W 40/04; B60W 10/20

(52) U.S. Cl. CPC B60W 30/12; B60W 10/20; B60W 40/04; B60W 50/082; B60W 60/001; B60W 60/0051; B60W 60/0061; B60W 2050/0073

(57) ABSTRACT

A method is provided for autonomously operating a vehicle. The method includes receiving vehicle state and vehicle environment data; determining that a vehicle position is not in a position for autonomous mode based on vehicle state and vehicle environment data, wherein the position is associated with a center of one lane of a roadway; enabling a steering assistance torque for a lane-centering operation concurrently within a pre-determined period of time of engagement of the autonomous mode for a vehicular operation; blending the steering assistance torque for assisting in vehicle guidance with a torque applied by the operator for the lane-centering operation with the autonomous mode of vehicular operation engaged; and executing enablement of the autonomous vehicular operation mode with the vehicle positioned within the center of one lane of the roadway as the operator is transitioned from a hands-on to a hands-off control of the vehicle.

### INTRODUCTION

The present disclosure generally relates to autonomous vehicles and more particularly relates to systems and methods for lane centering when actuating an autonomous mode of operation for an autonomous vehicle.

Advanced operator assistance systems (ADAS) capabilities such as lane departure warning, blind-spot detection, and emergency braking are commonplace and provided by manufacturers today. Further, more advanced semi-autonomous ADAS (S-ADAS) and autonomous vehicles functionalities are in various stages of rollout by manufacturers and include capabilities of sensing and navigating a vehicular environment with little or no user input.

Vehicle automation has been categorized into numerical levels ranging from Level Zero, corresponding to no automation with full human control, to Level Five, corresponding to full automation with no human control. Various automated operator-assistance systems, such as cruise control, adaptive cruise control, and parking assistance systems correspond to lower automation levels, while true “operator less” vehicles correspond to higher automation levels. Even though autonomous vehicles have made great advances in recent years, designers continue to seek improvements, particularly with respect to navigation functionality such as trajectory planning.

Accordingly, it is desirable to provide systems and methods that perform advanced vehicle lane-centering functions when actuating an autonomous mode of operation for semi-autonomous and autonomous driving systems, particularly systems and methods that address various driving environments and conditions.

Furthermore, other desirable features and characteristics of the systems and methods will become apparent from the subsequent detailed description and the appended claims, taken in conjunction with the accompanying drawings and the foregoing technical field and background.

### SUMMARY

A system is disclosed for automated lane centering of the vehicle and for transitioning an operator from a hands-on to a hands-off control of the vehicle with the activation of an autonomous driving system of the vehicle.

In at least one exemplary embodiment, a method for autonomously operating a vehicle is provided. The method includes receiving, by a processor, vehicle state data and vehicle environment data; in response to an operator engaging an autonomous mode of vehicular operation, determining, by the processor, that a vehicle position is not in a position for autonomous mode based on the vehicle state data and the vehicle environment data, wherein the position is associated with a center of one lane of a roadway; enabling, by the processor, a steering assistance torque for a lane-centering operation concurrently within a pre-determined period of time of engagement of the autonomous mode for a vehicular operation; blending, by the processor, the steering assistance torque for assisting in guidance of the vehicle together with a torque applied by the operator for the lane-centering operation with the autonomous mode of vehicular operation concurrently engaged; and executing, by the processor enablement of the autonomous mode of vehicular operation with the vehicle positioned within the center of one lane of the roadway as the operator is transitioned from a hands-on to a hands-off control of the vehicle.

In at least one exemplary embodiment, the method further includes in response to the operator engagement of the autonomous mode of the vehicular operation, calculating by the processor, a trajectory for a vehicular direction maneuver for positioning the vehicle within an approximate distance to the center of one lane wherein the trajectory is calculated to perform the vehicular direction maneuver based on optimal smoothness criteria wherein the vehicle with the approximate distance to the center of one lane includes a Stable In Lane (SIL) position.

In at least one exemplary embodiment, the method further includes in response to the operator engagement of the autonomous mode of the vehicular operation, determining, by the processor, operator intent based on a set of criteria including operator hand-off action while attempting to guide the vehicle with the steering assistance torque to reduce or to cease applying the steering assistance torque for a vehicular direction maneuver for centering the vehicle in one lane of the roadway.

In at least one exemplary embodiment, the method further includes wherein the lane-centering operation is terminated based on an operator action of an override.

In at least one exemplary embodiment, the method further includes determining, by the processor, the operator intent of the operator override action by a period of time of operator hand-off action, and a level of torque below a threshold that is applied by the operator in a hand-on control of the vehicular operation.

In at least one exemplary embodiment, the method further includes transitioning, by the processor, from a hand-on control of the vehicular operation to the hands-off control of the vehicular operation in the vehicular direction maneuver of the lane-centering operation while an operator assistance torque is applied by detecting a level of torque detected applied by the operator from the hand-on control of the vehicular operation.

In at least one exemplary embodiment, the method further includes in response to detection of one critical condition constraint associated with unexpected steering input during the hand-off control of the vehicular operation, backing-off or terminating, by the processor, applying the operator assistance torque in the vehicular direction maneuver for centering the vehicle in one lane of the roadway wherein the unexpected steering input includes an operator intervention action; and indicating, by the processor, by an operator notification the backing-off or terminating in application of the operator assistance torque in a vehicle direction maneuver for centering the vehicle in one lane of the roadway.

In at least one exemplary embodiment, the method further includes in response to detection of the one critical condition constraint associated with the unexpected steering input including operator hand-off control of the vehicular operation, enabling, by the processor, an intervention by the operator of the lane-centering operation and terminating the operator assistance torque for the guidance of the vehicle to within the center of one lane of the roadway.

In at least one exemplary embodiment, the method further includes wherein one critical condition constraint is associated with an operator applied threshold torque and a hand-on input detection based on the vehicle position that indicates a failure of an attempt of the hand-off control of the vehicular operation in the guidance of the vehicle within the center of one lane of the roadway.

In at least one exemplary embodiment, the method further includes in response to a determination of the failure of the hand-on control in the guidance of the vehicle within the center of one lane of the roadway, recovering, by the processor, a trajectory for vehicular direction for positioning the vehicle within the center of one lane with optimal smoothness criteria.

In another exemplary embodiment, an autonomous vehicle is provided. The autonomous vehicle includes at least one sensor that provides sensor data about objects within a vehicle environment as vehicle object environment data and about a vehicle state as vehicle state data; and a controller that, with a processor and based on the sensor data, is configured to: receive the vehicle state data and the vehicle environment data; determine that a vehicle position is not within a position for autonomous mode based on the vehicle state data and the vehicle environment data in response to an operator engagement of an autonomous mode of vehicular operation, wherein the position is associated with a center of one lane of a roadway; enable a steering assistance torque to assist in vehicle guidance for a lane-centering operation concurrently with the operator engagement of the autonomous mode of a vehicular operation; blend, in the lane-centering operation, the steering assistance torque within a period to time with a torque applied by an operator for the guidance of the vehicle for the lane-centering operation with the autonomous mode of vehicular operation concurrently engaged; and execute enablement of the autonomous mode of vehicular operation with the vehicle positioned within the center of one lane of the roadway as the operator is transitioned from a hands-on to hands-off vehicle control.

In at least one exemplary embodiment, the autonomous vehicle further includes wherein the controller is configured to in response to the operator engagement of the autonomous mode of the vehicular operation, calculate a trajectory for vehicular direction maneuver for positioning the vehicle within an approximate distance to the center of one lane wherein the trajectory is calculated to perform the vehicular direction maneuver based on optimal smoothness criteria wherein the vehicle with the approximate distance to the center of one lane includes a Stable In Lane (SIL) position.

In at least one exemplary embodiment, the autonomous vehicle further includes wherein the controller is configured to: in response to the operator engagement of the autonomous mode of the vehicular operation, determine operator intent based on a set of criteria including operator action while attempting to guide the vehicle with the steering assistance torque to reduce or to cease application of the steering assistance torque for the vehicular direction maneuver for centering the vehicle in one lane of the roadway.

In at least one exemplary embodiment, the autonomous vehicle further includes wherein the lane-centering operation is terminated based on the operator action of an override.

In at least one exemplary embodiment, the autonomous vehicle further includes wherein the controller is configured to determine the operator intent of the operator override action by a period of time of hands-off vehicular control and a level of torque below a threshold that is applied by the operator in a hand-on control of the vehicular operation.

In at least one exemplary embodiment, the autonomous vehicle further includes wherein the controller is configured to transition from the hand-on control of the vehicular operation to the hands-off control of the vehicular operation in the vehicular direction maneuver of the lane-centering operation while an operator assistance torque is applied by detecting the level of torque detected applied by the operator in the hand-on control of the vehicular operation.

In at least one exemplary embodiment, the autonomous vehicle further includes wherein the controller is configured to: in response to detection of one critical condition constraint associated with unexpected steering input by the operation during the hand-off control of the vehicular operation, either backing-off or terminating the operator assistance torque in the vehicular direction maneuver for centering the vehicle in one lane of the roadway; and indicate by an operator notification the backing-off or termination of the operator assistance torque in a vehicle guidance operation for centering the vehicle within one lane of the roadway.

In at least one exemplary embodiment, the autonomous vehicle further includes wherein the controller is configured to: in response to detection of one critical condition constraint associated with the unexpected steering input in the hand-off control of the vehicular operation, enable intervention by the operator of the lane-centering operation for intervening in the hand-off control of a vehicle operation by terminating the operator assistance torque for the guidance of the vehicle to within the center of one lane of the roadway.

In at least one exemplary embodiment, the autonomous vehicle further includes wherein the one critical condition constraint is associated with a period of time of the operator hand-off control of vehicle operation that indicates a failure of an attempt of the hand-on control of the vehicular operation in guidance of the vehicle within the center of one lane of the roadway.

In yet another exemplary embodiment, a system for vehicle lane-centering is provided. The system includes a processing unit disposed in a vehicle including one or more processors configured by programming instructions encoded on non-transient computer-readable media, the processing unit configured to: receive vehicle state data and vehicle environment data; determine that a vehicle position that is not within a position for autonomous mode based on the vehicle state data and the vehicle environment data in response to an operator engagement of an autonomous mode of vehicular operation wherein the position is associated with a center of one lane of a roadway; enable a steering assistance torque to assist in vehicle guidance for a lane-centering operation concurrently with the operator engagement of the autonomous mode of a vehicular operation; blend in the lane-centering operation, the steering assistance torque together with a torque applied by an operator for guidance of the vehicle for the lane-centering operation with the autonomous mode of vehicular operation concurrently engaged; execute enablement of the autonomous mode of vehicular operation with the vehicle is positioned within the center of one lane of the roadway as the operator is transitioned from a hands-on to hands-off vehicle control; and calculate a trajectory for vehicular direction maneuver to position the vehicle to an approximate distance to the center of one lane wherein the trajectory is calculated for the vehicular direction maneuver based on optimal smoothness criteria wherein the vehicle with the approximate distance to the center of one lane includes a Stable In Lane (SIL) position.

### BRIEF DESCRIPTION OF THE DRAWINGS

The exemplary embodiments will hereinafter be described in conjunction with the following drawing figures, wherein like numerals denote like elements, and wherein:

FIG. 1 illustrates a functional block diagram of an exemplary autonomous vehicle for use with the lane centering system, in accordance with various embodiments;

FIG. 2 illustrates a functional block diagram of a (backend communication) system having one or more autonomous vehicles of FIG. 1, in accordance with various embodiments;

FIG. 3 illustrates an exemplary diagram of an autonomous driving system that includes a lane-centering system of the autonomous vehicle, in accordance with various embodiments;

FIG. 4 illustrates an exemplary scenario of the operator’s view of a vehicle on a roadway between lanes moving in the direction of an adjacent lane when activating the autonomous driving mode of the vehicle and that also engages automatically with the vehicle lane-centering system, in accordance with various embodiments;

FIG. 5 illustrates an exemplary flow diagram of operator engagement of the vehicle lane-centering system, in accordance with an embodiment;

FIG. 6 illustrates an exemplary chart of actions between the various operable components and functions of an autonomous mode of vehicular operation in association with the lane centering operation system, in accordance with various embodiments;

FIG. 7 illustrates an exemplary diagram of states of a transition system of the vehicle controller for operable actions of the lane changing operation with indicators to the operator of the vehicle, in accordance with various embodiments;

FIG. 8 illustrates a diagram of an exemplary roadway with multiple target lanes for executing the lane centering system, in accordance with various embodiments; and

FIG. 9 illustrates a line graph of amounts of angular error of calculations in steering dynamics by the intervention of the steering torque assistance blended to achieve the stable in lane condition and activation of an autonomous mode of operation of the vehicle, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term module refers to any hardware, software, firmware, electronic control component, processing logic, and/or processor device, individually or in any combination, including without limitation: application-specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems and that the systems described herein are merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

In exemplary embodiments, the present disclosure describes systems, methods, and apparatuses to implement a process for blending hands-on steering of a vehicle path to transitioning to an automated hands-off lane-centering operation. The automated vehicular system is implemented using a lane-centering system steering assistance upon a request by the operator for the autonomous vehicular mode activation. With the automated hands-off centering process, the operator is no longer burdened with having to place the vehicle in the approximate center of the lane and then being able to activate the vehicle’s autonomous driving mode. In other words, it is commonplace for current autonomous driving systems to only enable activation with a so-called proper placement of the vehicle in the center of a lane before the system will allow the operator to activate the autonomous driving system of the vehicle.

In exemplary embodiments, the methodology described in the disclosure enables the active positioning of the vehicle in any currently driven lane (or in between lanes) in the direction that the vehicle is proceeding (e.g., a lane that the vehicle is switching into) which allows the operator not to have to consider any prior manual steps to place the vehicle in the middle of a lane of the roadway and then activate the autonomous driving system of the vehicle. From the operator’s perspective, this greatly reduces the complexity and driving obstacles currently present in the activation phase of an autonomous system, and further, the lane centering system provides further benefits such as convenient transitioning (i.e., reducing the complexity of the transitioning) from the hands-on to hands-off vehicle operations.

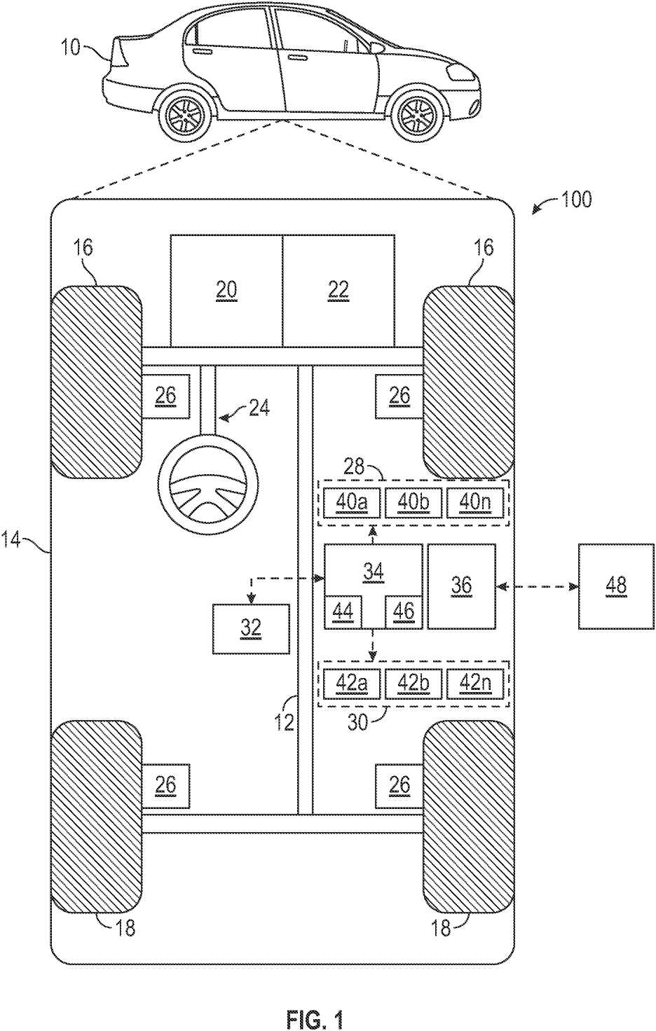

FIG. 1 illustrates a block diagram depicting an example vehicle 10 that may include a processor 44 that implements a lane-centering system 100. In general, input data is received in the lane centering system (or simply “system”) 100. System 100 determines a process for blending hands-on steering of a vehicle path to transitioning to an automated hands-off lane-centering operation based on the input data received.

As depicted in FIG. 1, vehicle 10 generally includes a chassis 12, a body 14, front wheels 16, and rear wheels 18. Body 14 is arranged on chassis 12 and substantially encloses components of vehicle 10. Body 14 and chassis 12 may jointly form a frame. The vehicle wheels 16-18 are each rotationally coupled to the chassis 12 near a respective corner of the body 14. Vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, etc., can also be used.

As shown, vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in this example, includes an electric machine such as a permanent magnet (PM) motor. The transmission system 22 is configured to transmit power from the propulsion system 20 to the vehicle wheels 16 and 18 according to selectable speed ratios.

The brake system 26 is configured to provide braking torque to the vehicle wheels 16 and 18. Brake system 26 may, in various exemplary embodiments, include friction brakes, brake by wire, a regenerative braking system such as an electric machine, and/or other appropriate braking systems.

The steering system 24 influences the position of the vehicle wheels 16 and/or 18. While depicted as including a steering wheel 25 for illustrative purposes, in some exemplary embodiments contemplated within the scope of the present disclosure, the steering system 24 may not include a steering wheel.

The sensor system 28 includes one or more sensing devices 40a-40n that sense observable conditions of the exterior environment and/or the interior environment of the vehicle 10 and generate sensor data relating thereto.

The actuator system 30 includes one or more actuator devices 42a-42n that control one or more vehicle features such as, but not limited to, the propulsion system 20, the transmission system 22, the steering system 24, and the brake system 26. In various exemplary embodiments, vehicle 10 may also include interior and/or exterior vehicle features not illustrated in FIG. 1, such as various doors, a trunk, and cabin features such as air, music, lighting, touch-screen display components, and the like.

The data storage device 32 stores data that can be used in controlling the vehicle 10. The data storage device 32 may be part of controller 34, separate from controller 34, or part of controller 34 and part of a separate system.

The controller 34 (i.e., vehicle controller) includes at least one processor 44 (integrate with system 100 or connected to the system 100) and a computer-readable storage device or media 46. The processor 44 may be any custom-made or commercially available processor, a central processing unit (CPU), a graphics processing unit (GPU), an application-specific integrated circuit (ASIC) (e.g., a custom ASIC implementing a neural network), a field-programmable gate array (FPGA), an auxiliary processor among several processors associated with the controller 34, a semiconductor-based microprocessor (in the form of a microchip or chipset), any combination thereof, or generally any device for executing instructions. The computer-readable storage device or media 46 may include volatile and non-volatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the processor 44, receive and process signals (e.g., sensor data) from the sensor system 28, perform logic, calculations, methods, and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

As an example, system 100 may include any number of additional sub-modules embedded within controller 34 which may be combined and/or further partitioned to similarly implement systems and methods described herein. Additionally, inputs to the system 100 may be received from the sensor system 28, received from other control modules (not shown) associated with the vehicle 10, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like.

An autonomous system may include a Level Four system which indicates “high automation”, referring to the driving mode-specific performance by an automated driving system of all aspects of the dynamic driving task, even if a human operator does not respond appropriately to a request to intervene; and a Level Five system which indicates “full automation”, referring to the full-time performance by an automated driving system of all aspects of the dynamic driving task under all roadway and environmental conditions that can be managed by a human operator.

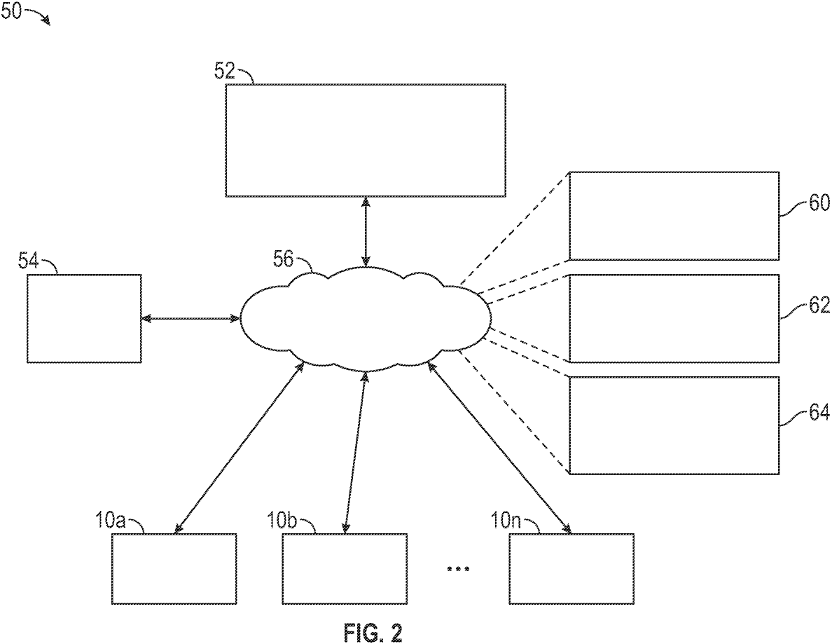

FIG. 2 illustrates an exemplary embodiment of an operating environment shown generally at 50 that includes an autonomous vehicle-based remote transportation system 52 that is associated with one or more autonomous vehicles 10a-10n as described with regard to FIG. 1. In various embodiments, the operating environment 50 further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 can include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including, for example, digital technologies such as CDMA (e.g., CDMA2000), LTE (e.g., 4G LTE or 5G LTE), GSM/GPRS, or other current or emerging wireless technologies. Other cell towers/base station / MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote (transportation) system 52 need not be connected via the land communication system 62 but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smartwatch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

As can be appreciated, the subject matter disclosed herein provides certain enhanced features and functionality to what may be considered as a standard or baseline autonomous vehicle 10 and/or an autonomous vehicle-based remote transportation system 52. To this end, an autonomous vehicle and autonomous vehicle-based remote transportation system can be modified, enhanced, or otherwise supplemented to provide the additional features described in more detail below.

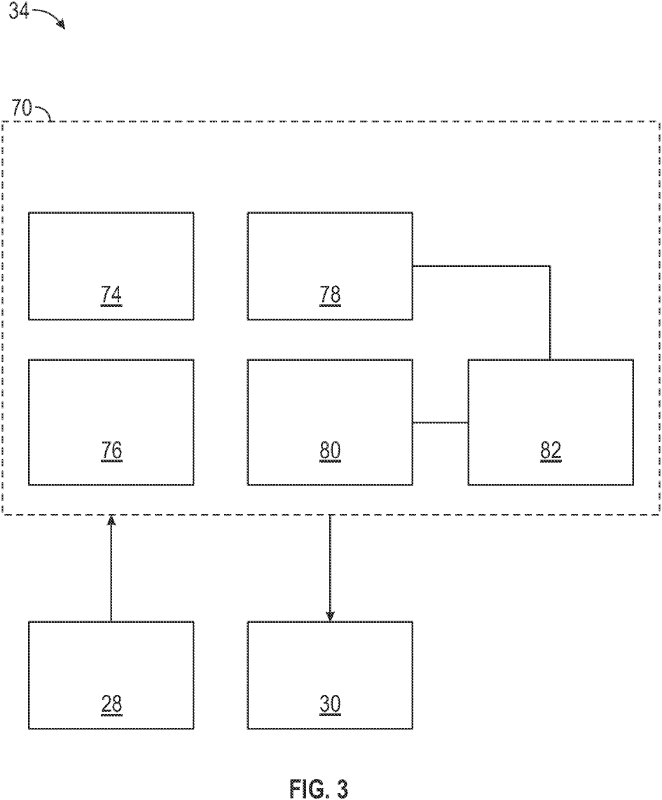

In accordance with various embodiments, controller 34 implements an autonomous driving system (ADS) 70 as shown in FIG. 3. That is, suitable software and/or hardware components of the controller 34 (e.g., the processor 44 and the computer-readable storage device 46) are utilized to provide an autonomous driving system 70 that is used in conjunction with vehicle 10.

In various embodiments, the instructions of the autonomous driving system 70 may be organized by function, module, or system. For example, as shown in FIG. 3, the autonomous driving system 70 can include a computer vision system 74, a positioning system 76, a guidance system 78, and a vehicle control system 80. The positioning system 76 may be in communication with a lane-centering system 82 that implements various algorithms to provide steering assistance to center the vehicle in a lane for activation of the other systems that make the vehicle’s autonomous driving system 70. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to the lane of a road, vehicle heading, velocity, etc.) of the vehicle 10 relative to the environment. The guidance system 78 processes sensor data along with other data to determine a path for vehicle 10 to follow. The vehicle control system 80 generates control signals for controlling the vehicle 10 according to the determined path.

In various embodiments, controller 34 implements machine learning techniques to assist the functionality of controller 34, such as feature detection/classification, obstruction mitigation, route traversal, mapping, sensor integration, ground-truth determination, and the like.

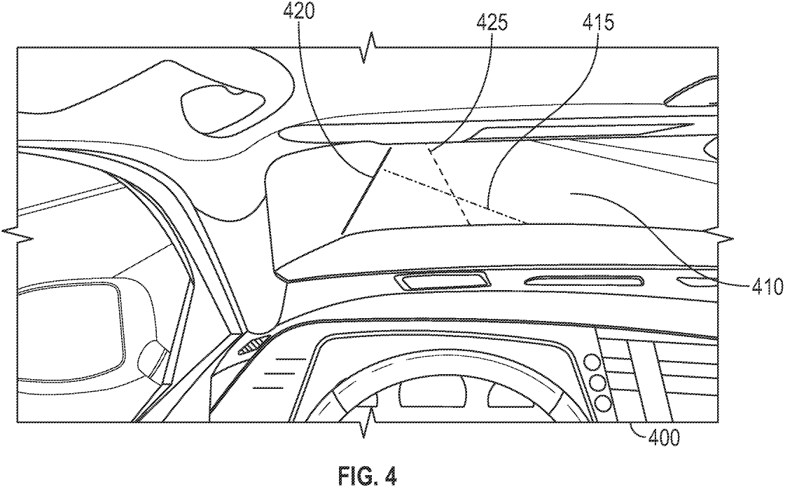

The autonomous driving system 70 is configured to execute steering and speed control maneuvers, amongst other possible autonomous driving possibilities, to avoid collisions and to move cooperatively with tracked objects based in part on the control commands. The autonomous driving system 70 operates known autonomous vehicle control computer instructions through a processor-based in part on the control data, as described below with respect to FIG. 4.

FIG. 4 depicts an exemplary scenario of the operator’s view of a vehicle on a roadway between lanes moving in the direction of an adjacent lane when activating the autonomous driving mode of the vehicle and also automatically engaging the vehicle lane-centering system in accordance with various embodiments. In FIG. 4, the operator view 410 from vehicle 400 is illustrated when vehicle 400 is in a position on the roadway that is not in the center of any lane but is partly positioned across lane 425. Vehicle 400 is following path 415 to the center 420 of an adjacent lane. In this instance, the operator may actuate the autonomous driving mode of the vehicle 400, and the autonomous driving mode is activated without the vehicle being positioned in the center of a lane on the roadway. Because vehicle 400 is positioned between lanes, a vehicle lane-centering system is also activated. The vehicle lane-centering system enables an automated assist in positioning vehicle 400 in the adjacent lane (i.e., in the center of the adjacent lane) to which the vehicle 400 is heading.

In various exemplary embodiments, as illustrated in FIG. 4, the autonomous driving mode of the vehicle may be triggered, enabled, or put in operation prior to the vehicle 400 being positioned by the operator in the center of a lane on the roadway. That is, the vehicle 400 is placed in an autonomous driving mode, regardless of the position of the vehicle 400 on the roadway; whether the vehicle 400 is in a lane, outside of the lane, adjacent to a lane, merging into a lane, crossing over a lane, and operating in any manner that the vehicle 400 is not in a center lane position.

In various exemplary embodiments, the vehicle lane-centering system enables the vehicle 400 with steering assistance that allows for automated steering assists to occur upon the vehicle lane-centering system is activated (for transitioning the operator from a hands-on vehicle operation to a hands-off vehicle operation) that negates reliance on the autonomous driving systems of the vehicle having to cause the operator to place the vehicle in a proper lane position such as the center of the lane prior to activation of an autonomous driving system of the vehicle 400. In various exemplary embodiments, as depicted in FIG. 4, the vehicle lane-centering system assists, or automatically enables proper vehicle positioning in a center (or like position) of the lane on the roadway in which the vehicle is heading without manual operation on the part of the operator. In embodiments, the vehicle lane-centering system as depicted in FIG. 4 (by the location of the vehicle between lanes) eliminates the additional step, burden, or manual operative actions on the part of the operator customarily prior to activating an autonomous state, autonomous mode, or the like including any level of autonomous enablement of the vehicle 400 of having to position the vehicle, or the vehicle is positioned, or being positioned in the center region of the lane or close to the center of a lane when activating the autonomous or autonomous like modes of operation, or placement by vehicular systems (in response to the operator request of an autonomous state) of the vehicle in an autonomous state (i.e., hands-free without manual intervention). Thus, the vehicle lane-centering system provides the operator with an earlier opportunity to activate the autonomous driving mode or state of the vehicle prior to proper lane positioning or for that matter any lane positioning.

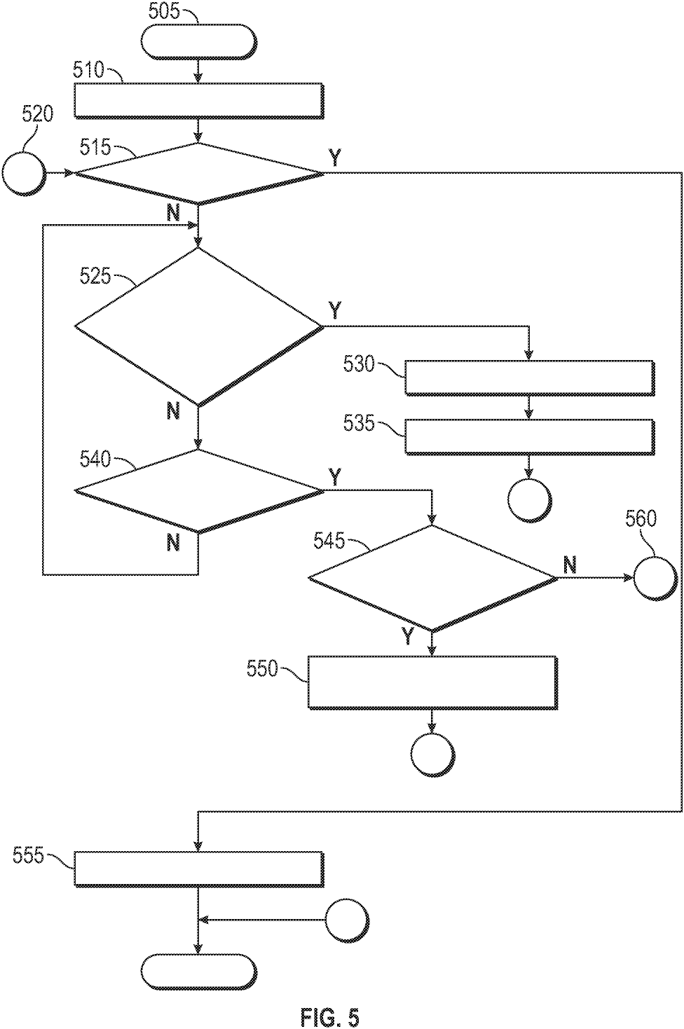

FIG. 5 is an exemplary flowchart illustrating a method for operator engagement of the vehicle lane-centering system in accordance with an embodiment. As can be appreciated in light of the disclosure, the order of operation within the method is not limited to the sequential execution as illustrated in FIG. 5 but may be performed in one or more varying orders as applicable and in accordance with the present disclosure. In various embodiments, the method can be scheduled to run based on one or more predetermined events, and/or can run continuously during the operation of vehicle 10.

The method may begin at 505. At step 510, the operator executes a request to engage the autonomous mode for the autonomous operation of the vehicle. At the time of the operator’s request, in step 510, the vehicle may or may not be centered in the center or middle of a lane of the roadway. For example, the operator may have executed a maneuver and is heading in a direction crossing an adjacent lane, or the operator has not positioned the vehicle in the middle of a lane. In either case, the vehicle is a distance from the center of the lane of a roadway and this prevents the autonomous driving mode to be activated (as the autonomous driving modes require proper placement in the middle of a lane prior to activation). At step 515, concurrent with the request for the operator to engage in the autonomous mode of operation, the controller of the vehicle determines based on sensed data of the objects about the vehicle (for example detection via vehicle cameras of imagery about the vehicle) of the vehicle position and received data of the vehicle state whether the vehicle is in a Stable In Lane (SIL) state or condition. That is, through a plethora of sensed data from multiple sensors as well as GPS mapping data, and by various algorithmic solutions fusing the received data, the (vehicular) controller determines whether the vehicle is approximate within a certain distance threshold criteria to the middle of the lane of the roadway. Other factors are used to determine whether the vehicle is correctly positioned relative to the center of a lane which includes the current vehicle heading, the curvature of the roadway, the direction of the lane, the torque applied to the steering wheel by the operator, and the direction or inputs received of hands-on control by the operator (i.e., how the operator is holding the steering wheel). If at step 515, the vehicle is determined to be in a stable in lane condition, then the autonomous mode is engaged without the need for executing the lane centering operation or applying any additional operator assistance torque. The controller determines that the vehicle position is proper for engagement of the autonomous driving mode and the vehicle is properly positioned within an approximate distance of the center of one of the lanes in the roadway.

Alternately, in an exemplary embodiment, if the vehicle is determined not to be in a stable lane condition state, then the controller essentially determines that the vehicle is not in a proper position for the autonomous mode of vehicle operation and requires a vehicular maneuver to place to the vehicle in the proper position for the autonomous mode of operation. Even though the vehicle is not in the proper position, because of the concurrent execution of the lane centering operation, the vehicle is placed in the autonomous mode of operation. Hence, the lane centering operation is combined with the autonomous functionality to exhibit a seamless state of the vehicle already entering an autonomous mode of operation without the operator having to re-request the autonomous mode of vehicular operations.

At step 525, the (vehicle) controller determines whether the operator is in a hands-off state after requesting the autonomous mode. A time interval is triggered with a time constraint to determine whether to initiate a backoff or to cease the steering assistance torque that assists the operator in the guidance of the vehicle to the center position of a lane of the roadway. For example, the operator may request the autonomous mode and hand-off the vehicle control, and then the operator may decide to make an intervention to the autonomous mode (system) and take control of the vehicle operation, or the operator may resist the automated torque applied to the steering wheel causing the lane centering system to disconnect. If the time period is not exceeded for the operator intervention which is indicative to the vehicle controller that the operator not taking hands-on control of the vehicle, and the operator intent is a continued engagement of the autonomous mode of operation, then the lane centering system continues, else it initiates a back-off or a cease of the lane centering function at step 530. With the back-off or the cease in operation, the vehicle controller sends at step 535 a message or notification to the operator that the center lane guidance, and/or the autonomous mode is no longer active.

At step 540, a determination is made by the controller of detections of the vehicle or operator maneuver actions that are attempted (via vehicle trajectories) towards the approximate center position of a lane based on received sensed data and detected vehicle operational data by the vehicle controller. If a centering attempt is detected, then at step 545 a determination of whether an operator applied torque is below a certain threshold and that additional torque assistance is required to assist in a vehicle maneuver to direct or move the vehicle in a direction towards the center of a lane. If the torque is below a threshold, then at step 550, a blending operation takes place of blending torque assistance applied by the centering lane operation with the operator applied torque to provide better guidance or to aid the operator in guidance towards the lane center. In an embodiment, the steering assistance torque is provided together with a torque applied by the operator for the guidance of the vehicle for the lane-centering operation with the autonomous mode of vehicular operation concurrently engaged. The torque assistance by the controller is reduced, terminated, or ceased (eliminated) at step 560 when the vehicle is in the stable in lane (SIL) condition. At step 555, the autonomous mode of operation is implemented with the vehicle in the SIL condition met.

In exemplary embodiments, the operator intent in the control at step 545 of the vehicle is determined after a pre-set or predetermined time period by the vehicle controller based on vehicle state data received vehicle position data, and data about other obstacles sensed by vehicle sensors about the vehicle environments (i.e., centerline markings, and other road marking such as rumble strips, tactile road guidance vibrations, audible strip rumbles, etc..); the vehicle controller determines based on the data received using software and processor implemented algorithmic solutions whether a centering by the operator control is being attempted to position the vehicle in a lane center. If the operator is resisting the torque provided or takes other unexpected actions then the lane centering system disconnects its operation and notifies the operator that lane-centering operations are not in transition or have ceased or terminated by alert color indicators.

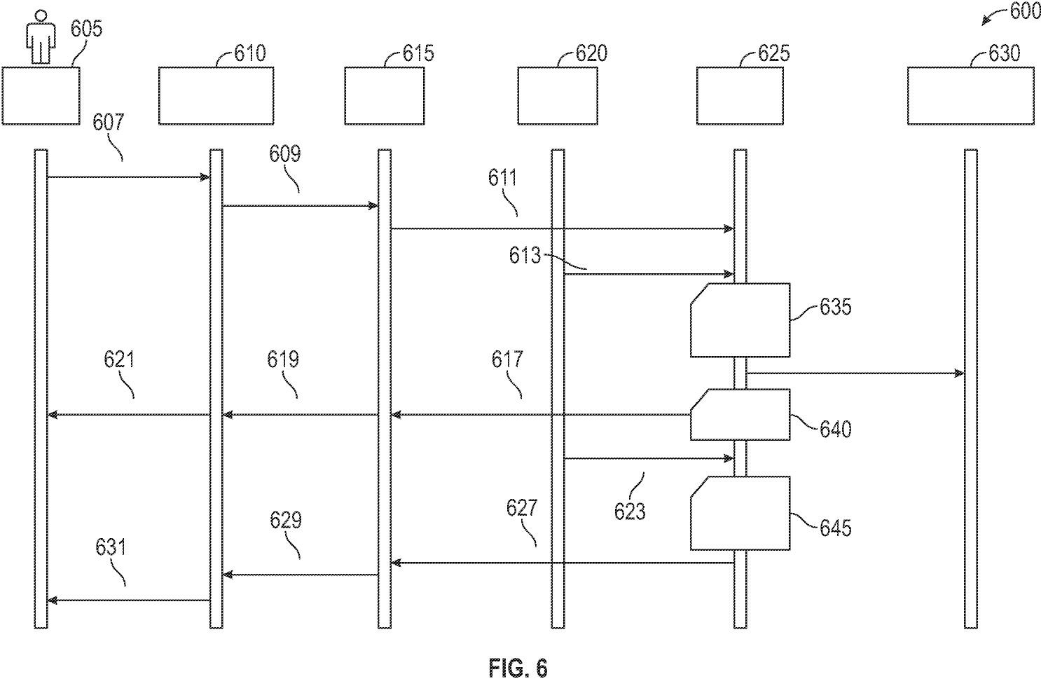

FIG. 6 is an exemplary sequence diagram illustrating actions and timing between the various operable components and functions of an autonomous mode of vehicular operation in association with the lane centering operation system in accordance with various embodiments.

In FIG. 6, operator 605 is presented with an option selection 607 for the autonomous mode or the like. The operator or other occupant 610 who is interacting with the vehicle controls, activates at 609 the steering control directly or indirectly. For example, this activation step may include triggering the autonomous mode directly via a button, selection on a display, or by a shifter coupled with the steering wheel to initiate a feature mode 615. Once activated, a transition stage 611 is initiated to transition to the fully autonomous mode by executing steering control operations that cause lateral execution 625 to occur in vehicular operations. At 613, the vehicle controller monitors the current stable in lane condition and determines that the vehicle is not stable in a lane (SIL), and initiates a blending steering control torque 635 with the operator torque so long as the operator applied torque is below a threshold. The request for additional steering wheel torque is sent to the power steering system 630 of the vehicle. Also, the vehicle controller monitors the hands-on 640 states of the operator. For example, the vehicle controller determines whether the operator has conceded control, and is hands-off 617, or continues to apply a torque to the steering wheel to attempt to properly position the vehicle, to assess activation of the centering lane system. In conjunction with the hands-off monitoring, various alerts are issued by the vehicle including alert commands 619 and alert indications 621 that the operator is hands-off, and that the vehicle is instituting the automated lane centering system of lateral executions in the operation of the vehicle. Next, at some point, a SIL condition 623 is achieved where the vehicle based on sensed data and vehicle state data is determined by the vehicle controller to be near or at the approximate center of a lane in the roadway (transition from a hands-on to a hands-off is completed). At 645, steering control is assumed, and at 627 the controller is fully in control of the steering operations of the vehicle in the autonomous mode. The feature mode 615 of the vehicle, transitions to an active mode 629, and an alert or indicator are updated; in this case to a Green indicator 631 that the feature mode is active or that the vehicle is in an autonomous mode of operation.

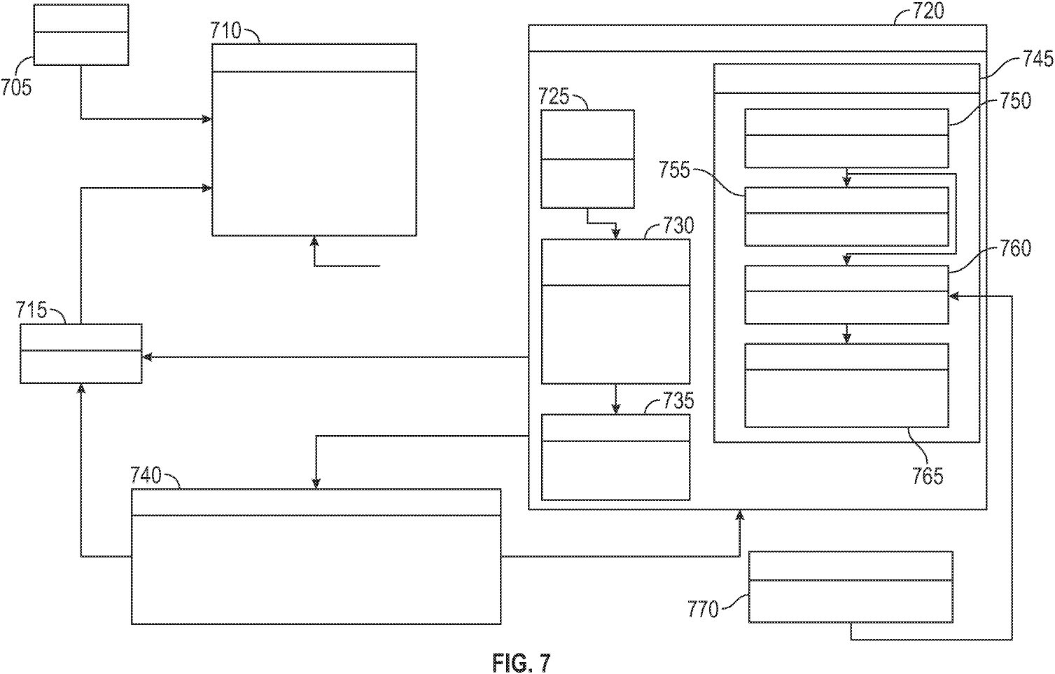

FIG. 7 illustrates an exemplary state transition diagram of a state transition system of the lane centering system in exemplary embodiments. The state transition system includes a plurality of states and transitions. In FIG. 7, at an “ON” state 705 the autonomous mode of operation is enabled (e.g., an operator selection of an “ON” action of vehicular operation). Next, the state transition system transitions to an “UNAVAILABLE” state 710, this is after the selection of the autonomous mode of operation and the vehicle autonomous control state has transitioned “ON”. in the “UNAVAILABLE” state 710, a number of determinations are made by the vehicle controller including whether the lane-centering system is enabled, or whether certain conditions of the vehicle operation need to be confirmed for transition to available. Alternately, whether the lane-centering system is disabled or not applicable. Then the state transition system transitions (from an “UNAVAILABLE” state) to an “AVAILABLE” state 720. In the “AVAILABLE” state 720, the vehicle controller (has deemed that an assist action is feasible) determines the availability of the lane centering system by instituting a set of steps defined by the states shown of a system ACTIVATION state 725 to transition to a blue alert state (initialization of the lane centering system with the autonomous driving request), operator “ENGAGEMENT DETECTION” state 730 for transitioning vehicle operation from a hands-on steering control by the operator in which the operator is attempting to center the vehicle in a lane; to a “MANEUVER EXECUTION” state 735 in which a maneuver execution sent by the controller to assist in engagement of the autonomous mode. A series of indicator alerts are shown in a “SYSTEM MESSAGING AND VISUAL ALERT” state 745 that includes a “BLUE” state 750, in which the vehicle controller generates a blue indicator alert if the vehicle is SIL, else the indicator alert is generated as a red indicator alert signaling the vehicle is not in a SIL. Next, the transition system transitions to a “GREEN” state 755 in which the controller determines if the green criterion is met and then a green indicator alert may be displayed, if not then the controller switches to a “RED” state 760 in which the transition system transitions to a recovery mode and the vehicle controller may display a red indicator alert indicative to the operator that a recovery mode has commenced. In the “TAKE CONTROL” 765, the operator is instructed via a voice alert to take control (if the driver is unresponsive) during or after the recovery mode, or if the recovery mode has ceased. Also, the system may transition to a “SAFETY MONITOR” state 770 to send an input that a failure has been detected to transition to a recovery mode in a “RED” state 760.

In embodiments, the transition system may transition from a “MANEUVER EXECUTION” state 735 to a “HANDOFF” state 740 in which the vehicle controller institutes a controlled handoff of vehicle operations by blending torque to the steering control (with the driver torque) to achieve the SIL position. If the SIL is achieved then the transition system transition to the “GREEN” state 755 and displays a green indicator alert notifying the operator of the handoff vehicle control, else if the operator overrides then the alert remains (i.e., “BLUE” state 750) and displays a blue indicator alert; it may or may not transition to “RED” state 760 and display the red indicator alert. In the “DISABLED” state 715, the transition system may determine that the SIL position of the vehicle has been achieved and the lane-centering system is then disabled or is disabled if the availability criterion is violated.

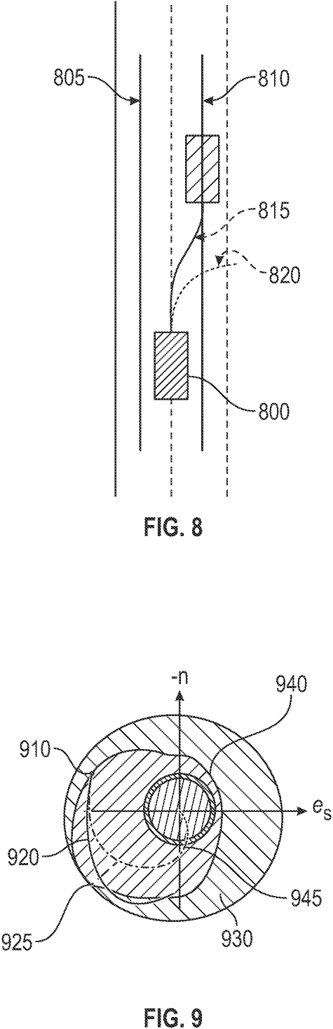

FIG. 8 depicts an exemplary roadway with multiple target lanes for executing the lane centering system in accordance with various embodiments. In FIG. 8, the lane centering system creates a number of possible target lanes to steer or guide the vehicle to and to achieve the SIL condition. These include a primary target lane 810 and a secondary target lane 805 for vehicle 800. The lane centering system analyzes operator inputs, steering wheel angles, and vehicle path 820 to select the primary target lane 810. The lane centering system determines a blended path trajectory 815 with a smoothing criterion to achieve the SIL in the primary target lane 810. For example, the lane centering system implements an algorithm that configures various processors of the vehicle controller to calculate a vehicle trajectory via a blended path trajectory 815 from the vehicle path 820 with certain path rate limits for smoothing the approach (i.e., based on vehicle speed, road width, lane width, road curvature, etc..) for a smooth maneuver to enable a multiple factored criterion including a smooth dynamic motion for lateral and heading control of the vehicle to achieve the approximate center position in the primary lane, to minimize trajectory lateral position error, and to enable zero heading for path convergence to the primary lane.

In exemplary embodiments, a system model is generated for the blending control of the steering assistance torque with the operator applied torque of the lane centering system. The control of the steering torque is applied smoothly by the lane-centering system by blending operator torque and moving the vehicle to a stable position in the lane, in a controlled manner that causes the operator not to oppose the torque applied by the lane-centering system. That is, if the torque applied by the lane-centering system is applied in a manner of higher than expected magnitude to the operator or not in a smooth or otherwise controlled operation, it can cause the operator to resist the applied torque and initiate or direct an override action to cease or stop the lane centering operation and the torque assistance provided to guide the vehicle.

To enable the control of the torque smoothly, in an exemplary embodiment, the criterion or logic is followed to enable the transition from hands-on control to the hands-off control of the vehicle operation.

In an embodiment, the vehicle controller implements a stable in lane objective in which the vehicle should move towards the center of the lane based on a (tracking error e) that should be continuously minimized: e → 0. The vehicle controller executes an algorithm for blending torque applied from the operator and to ensure that the lane centering system does not initiate the vehicle controller to resist any torque applied by the operator (based on the operator intent) but to act in a manner that is consistent for a smooth assist of the operator torque τ_{D} application via a feedback mechanism. The following formulation demonstrates an implementation example that constraints the control torque to blend driver torque in and work with the driver to achieve the control’s obj ective.

$$\left|{τ}_{c} - {τ}_{D}\right| < \left|{τ}_{o}\right|$$

Where τₒ is a maximum control torque provided to resist the operator torque that the operator applies.

In implementing the control and guaranteeing τ_{c} (Torque Control) satisfies the following characteristics by using mathematical equations (i.e., Lyapunov’s candidate) with enhancements to address the constraint, |τ_{c} - τ_{D}| < |τₒ|, as a penalty on the control torque as follows:

$$V = {\underbrace{\frac{1}{2} {e}^{\text{T}} \text{Q} e + \frac{{k}_{4}}{2} {\dot{e}}_{6}^{2}}}_{{V}_{1}} + {\underbrace{\frac{{k}_{3}}{2} \text{ln} \left(\frac{{c}^{2}}{{c}^{2} - {\dot{e}}_{6}^{2}}\right)}}_{{V}_{2}}$$

Where e₅ is the handwheel angle error and e₆ is the handwheel angle error rate.

where Q is a positive definite matrix, k₃, k₄ >0 are design parameters, and c is defined as:

$$c = \frac{\left|{τ}_{o}\right|}{{J}_{m}} + \left|{\dot{x}}_{6 , d}\right| + \frac{{c}_{w}}{{J}_{w}} \left|{x}_{5}\right| + \frac{b {}_{w}}{{J}_{w}} \left|{x}_{6}\right|$$

And Lemma₁: if |ė₆| <c, then the following constraint is satisfied

$$\left|{τ}_{c} - {τ}_{D}\right| < \left|{τ}_{o}\right|$$

The following shows the proof of the Lemma: calculating the upper bound for |ė₆| is as follows:

$$\left|{\dot{e}}_{6}\right| \leq \left|{\dot{x}}_{6 , d} - {\dot{x}}_{6}\right| \leq \left|{\dot{x}}_{6 , d}\right| + \left|{\dot{x}}_{6}\right|$$

$$\left|{\dot{e}}_{6}\right| \leq \left|{\dot{x}}_{6 , d} - {\dot{x}}_{6}\right| \leq \frac{{c}_{w}}{{J}_{w}} \left|{x}_{5}\right| + \frac{{b}_{w}}{{J}_{w}} \left|{x}_{6}\right| + \frac{\left|τ - {τ}_{D}\right|}{{J}_{w}} + \left|{\dot{x}}_{6 , d}\right|$$

Knowing |τ_{c} - τ_{D}| < |τₒ| and defining c as

$$\left|{\dot{e}}_{6}\right| < {\overbrace{\frac{\left|{τ}_{o}\right|}{{J}_{w}} + \left|{\dot{x}}_{6 , d}\right| + \frac{{c}_{w}}{{J}_{w}} \left|{x}_{5}\right| + \frac{{b}_{w}}{{J}_{w}} \left|{x}_{6}\right|}}^{c}$$

V₁ is for control and follows Lyapunov’s conditions; V₂ satisfies Lyapunov’s candidate function conditions:

$$\text{If} {V}_{2} = 0 , {e}_{5} \to 0 , {e}_{6} \to 0 ; \text{otherwise} {V}_{2} > 0.$$

$$\text{If} {\dot{V}}_{2} < 0 , \text{since} {V}_{2} \geq 0 , {V}_{2} \to 0.$$

Then the (torque control) is calculated as τ_{c} that guarantees

$$\dot{V} < 0$$

The lane-centering system is implemented as follows:

Lemma₂: The following control law stabilizes e₅, e₆ around the origin, while also keeping the control torque working smoothly with operator torque.

$${τ}_{c} = {τ}_{D} + {J}_{w} {\ddot{δ}}_{d} + {c}_{w} δ + {k}_{1} {e}_{5} + {k}_{2} {e}_{6} - {J}_{w} Δ$$

Where J_{w} is an inertia coefficient, δ is the road wheel angle, c is a design parameter for over the ride limit; δ_{d} is the tracking control that stabilizes e → 0.

Where Δ (error modifier) can be defined as

$$Δ = \frac{{k}_{2}}{2 {J}_{w}} + {\frac{\left({k}_{2}^{2} + 4 \left({k}_{4} + \frac{{k}_{3}}{{c}^{2} - {\dot{e}}_{6}^{2}}\right) {k}_{1}\right)}{2 {J}_{w}}}^{\frac{1}{2}} - 1$$

; that results in

$${\dot{V}}_{2} = - \frac{{k}_{2}}{{J}_{w} \left(1 + Δ\right)} {e}_{6}^{2} \left({k}_{2} - {k}_{1} {c}_{1}\right) - {k}_{2} {c}_{1} {\dot{e}}_{6}^{2}$$

where

$${c}_{1} = \frac{\left({k}_{4} + \frac{{k}_{3}}{{c}^{2} - {\dot{e}}_{6}^{2}}\right)}{{J}_{w} \left(1 + Δ\right)}$$

which assures V̇₂ ≤ 0 meaning |ė₆| < c. This theoretically guarantees that this approach centers the vehicle while systematically acknowledging and blends the driver’s torque in the control.

It is contemplated that in embodiments, the described formulation can be changed, and other forms of the modifier described above can be implemented using the same or similar approach or methodology.

since |ė₆| < c,Δ > -1.

Where k₁, k₂, k₃, k₄ > 0 are design parameters (Calibrations)

Where the tracking error signal for the hand to wheel angle control is defined as: e₅ = x_{5,d} - x₅, and e₆ = x_{6,d} - x₆.

FIG. 9 is a line graph illustrating amounts of angular error of calculations in steering dynamics by the intervention of the steering torque assistance blended to achieve the stable in lane condition and activation of an autonomous mode of operation of the vehicle in accordance with various embodiments.

In FIG. 9, in an exemplary embodiment, the autonomous mode is triggered at 910, and the operator input of applied torque to the steering wheel is shown at 920. At 925 the smooth blending from the drive input torque is shown to decrease the driver input applied. At 930, the autonomous mode transition by the blue alert indicator which is indicative of transitioning to the autonomous mode. At 940, the activation region is expanded by the blending of the operator torque because of the operator engagement assistance provided by the lane centering system. Also shown at 945 is the control input curve after activation.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary aspect has been presented in the foregoing detailed description of the invention, it should be appreciated that a vast number of variations exist. It should also be appreciated that the exemplary aspect or exemplary aspects are only examples, and are not intended to limit the scope, applicability, or configuration of the invention in any way. Rather, the foregoing detailed description will provide those skilled in the art with a convenient road map for implementing an exemplary aspect of the invention. It is understood that various changes may be made in the function and arrangement of elements described in an exemplary aspect without departing from the scope of the invention as set forth in the appended claims.

What is claimed is:

1. A method for autonomously operating a vehicle, comprising:
receiving, by a processor, vehicle state data and vehicle environment data;
in response to an operator engaging an autonomous mode of vehicular operation, determining, by the processor, that a vehicle position is not in a position for autonomous mode based on the vehicle state data and the vehicle environment data, wherein the position is associated with a center of one lane of a roadway;
enabling, by the processor, a steering assistance torque for a lane-centering operation concurrently within a pre-determined period of time of engagement of the autonomous mode for a vehicular operation;
blending, by the processor, the steering assistance torque for assisting in guidance of the vehicle together with a torque applied by the operator for the lane-centering operation with the autonomous mode of vehicular operation concurrently engaged; and
executing, by the processor, enablement of the autonomous mode of vehicular operation with the vehicle positioned within the center of one lane of the roadway as the operator is transitioned from a hands-on to a hands-off control of the vehicle.

2. The method of claim 1, further comprising:
in response to operator engagement of the autonomous mode of the vehicular operation, calculating by the processor, a trajectory for a vehicular direction maneuver for positioning the vehicle within an approximate distance to the center of one lane wherein the trajectory is calculated to perform the vehicular direction maneuver based on optimal smoothness criteria wherein the vehicle with the approximate distance to the center of one lane comprises a Stable In Lane (SIL) position.

3. The method of claim 1, further comprising:
in response to operator engagement of the autonomous mode of the vehicular operation, determining, by the processor, operator intent based on a set of criteria comprising operator hand-off action while attempting to guide the vehicle with the steering assistance torque to reduce or to cease applying the steering assistance torque for a vehicular direction maneuver for centering the vehicle in one lane of the roadway.

4. The method of claim 3, wherein the lane-centering operation is terminated based on an operator action of an override.

5. The method of claim 4, further comprising:
determining, by the processor, the operator intent of the operator override action by a period of time of operator hand-off action, and a level of torque below a threshold that is applied by the operator in a hand-on control of the vehicular operation.

6. The method of claim 4, further comprising:
transitioning, by the processor, from a hand-on control of the vehicular operation to the hands-off control of the vehicular operation in the vehicular direction maneuver of the lane-centering operation while an operator assistance torque is applied by detecting a level of torque detected applied by the operator from the hand-on control of the vehicular operation.

7. The method of claim 6, further comprising:
in response to detection of one critical condition constraint associated with unexpected steering input during the hand-off control of the vehicular operation, backing-off or terminating, by the processor, applying the operator assistance torque in the vehicular direction maneuver for centering the vehicle in one lane of the roadway wherein the unexpected steering input comprises an operator intervention action; and
indicating, by the processor, by an operator notification the backing-off or terminating in application of the operator assistance torque in a vehicle direction maneuver for centering the vehicle in one lane of the roadway.

8. The method of claim 7, further comprising:
in response to detection of the one critical condition constraint associated with the unexpected steering input comprising operator hand-off control of the vehicular operation, enabling, by the processor, an intervention by the operator of the lane-centering operation and terminating the operator assistance torque for the guidance of the vehicle to within the center of one lane of the roadway.

9. The method of claim 8, wherein the one critical condition constraint is associated with an operator applied threshold torque and a hand-on input detection based on the vehicle position that indicates a failure of an attempt of the hand-off control of the vehicular operation in the guidance of the vehicle within the center of one lane of the roadway.

10. The method of claim 9, further comprising:
in response to a determination of the failure of the hand-on control in the guidance of the vehicle within the center of one lane of the roadway, recovering, by the processor, a trajectory for vehicular direction for positioning the vehicle within the center of one lane with optimal smoothness criteria.

11. An autonomous vehicle, comprising:
at least one sensor that provides sensor data about objects within a vehicle environment as vehicle object environment data and about a vehicle state as vehicle state data; and
a controller that, with a processor and based on the sensor data, is configured to:
receive the vehicle state data and the vehicle environment data;
determine that a vehicle position is not within a position for autonomous mode based on the vehicle state data and the vehicle environment data in response to an operator engagement of an autonomous mode of vehicular operation, wherein the position is associated with a center of one lane of a roadway;
enable a steering assistance torque to assist in vehicle guidance for a lane-centering operation concurrently with the operator engagement of the autonomous mode of a vehicular operation;
blend, in the lane-centering operation, the steering assistance torque within a period to time with a torque applied by an operator for the guidance of the vehicle for the lane-centering operation with the autonomous mode of vehicular operation concurrently engaged; and
execute enablement of the autonomous mode of vehicular operation with the vehicle positioned within the center of one lane of the roadway as the operator is transitioned from a hands-on to hands-off vehicle control.

12. The autonomous vehicle of claim 11, wherein the controller is configured to:
in response to the operator engagement of the autonomous mode of the vehicular operation, calculate a trajectory for vehicular direction maneuver for positioning the vehicle within an approximate distance to the center of one lane wherein the trajectory is calculated to perform the vehicular direction maneuver based on optimal smoothness criteria wherein the vehicle with the approximate distance to the center of one lane comprises a Stable In Lane (SIL) position.

13. The autonomous vehicle of claim 12, wherein the controller is configured to:
in response to the operator engagement of the autonomous mode of the vehicular operation, determine operator intent based on a set of criteria comprising operator action while attempting to guide the vehicle with the steering assistance torque to reduce or to cease application of the steering assistance torque for the vehicular direction maneuver for centering the vehicle in one lane of the roadway.

14. The autonomous vehicle of claim 13, wherein the lane-centering operation is terminated based on the operator action of an override.

15. The autonomous vehicle of claim 14, wherein the controller is configured to:
determine the operator intent of the operator override action by a period of time of hands-off vehicular control and a level of torque below a threshold that is applied by the operator in a hand-on control of the vehicular operation.

16. The autonomous vehicle of claim 15, wherein the controller is configured to:
transition from the hand-on control of the vehicular operation to the hands-off control of the vehicular operation in the vehicular direction maneuver of the lane-centering operation while an operator assistance torque is applied by detecting the level of torque detected applied by the operator in the hand-on control of the vehicular operation.

17. The autonomous vehicle of claim 16, wherein the controller is configured to:
in response to detection of one critical condition constraint associated with unexpected steering input by operation during the hand-off control of the vehicular operation, either backing-off or terminating the operator assistance torque in the vehicular direction maneuver for centering the vehicle in one lane of the roadway; and
indicate by an operator notification the backing-off or termination of the operator assistance torque in a vehicle guidance operation for centering the vehicle within one lane of the roadway.

18. The autonomous vehicle of claim 17, wherein the controller is configured to:
in response to detection of the one critical condition constraint associated with the unexpected steering input in the hand-off control of the vehicular operation, enable intervention by the operator of the lane-centering operation for intervening in the hand-off control of a vehicle operation by terminating the operator assistance torque for the guidance of the vehicle to within the center of one lane of the roadway.

19. The autonomous vehicle of claim 18, wherein the one critical condition constraint is associated with a period of time of the operator hand-off control of vehicle operation that indicates a failure of an attempt of the hand-on control of the vehicular operation in guidance of the vehicle within the center of one lane of the roadway.

20. A system for vehicle lane-centering comprising:
a processing unit disposed in a vehicle comprising one or more processors configured by programming instructions encoded on non-transient computer-readable media, the processing unit configured to:
receive vehicle state data and vehicle environment data;
determine that a vehicle position that is not within a position for autonomous mode based on the vehicle state data and the vehicle environment data in response to an operator engagement of an autonomous mode of vehicular operation wherein the position is associated with a center of one lane of a roadway;
enable a steering assistance torque to assist in vehicle guidance for a lane-centering operation concurrently with the operator engagement of the autonomous mode of a vehicular operation;
blend in the lane-centering operation, the steering assistance torque together with a torque applied by an operator for guidance of the vehicle for the lane-centering operation with the autonomous mode of vehicular operation concurrently engaged;
execute enablement of the autonomous mode of vehicular operation with the vehicle is positioned within the center of one lane of the roadway as the operator is transitioned from a hands-on to hands-off vehicle control; and
calculate a trajectory for vehicular direction maneuver to position the vehicle to an approximate distance to the center of one lane wherein the trajectory is calculated for the vehicular direction maneuver based on optimal smoothness criteria wherein the vehicle with the approximate distance to the center of one lane comprises a Stable In Lane (SIL) position.
